(19) United States
(12) Patent Application Publication
(10) Pub. No.: US 2020/0008376 A1
(43) Pub. Date: Jan. 9, 2020

(54) Aeroponic System and Method

(71) Applicant: Just Greens, LLC, Newark, NJ (US)

(72) Inventor: Edward D. Harwood, Ithaca, NY (US)

(73) Assignee: Just Greens, LLC, Newark, NJ (US)

(21) Appl. No.: 16/574,480

(22) Filed: Sep. 18, 2019

Related U.S. Application Data
(63) Continuation of application No. 15/945,993, filed on Apr. 5, 2018.
Application No. 15/945,993 is a continuation of application No. 13/683,700, filed on Nov. 21, 2012, now abandoned.

(51) Int. Cl. A01G 31/02

(52) U.S. Cl. CPC A01G 31/02; Y02P 60/216

(57) ABSTRACT

Exemplary embodiments are directed to an improvement of an aeroponic system including a growth chamber and cloth support elements. The improvement generally includes a cloth supported by the cloth support elements. The cloth advantageously satisfies a wicking height parameter and an absorbance parameter so as to deliver advantageous aeroponic performance. The wicking height parameter is a measurement of an ability of the cloth or fabric to absorb moisture. The absorbance parameter is a measurement of moisture the cloth or fabric retains. Exemplary methods of aeroponic farming in an aeroponic system are also provided.

### CROSS-REFERENCE TO RELATED APPLICATION

The present application is a continuation application that claims priority benefit to a non-provisional patent application entitled “Improvement of an Aeroponic System and Method,” which was filed on Apr. 5, 2018, and assigned Ser. No. 15/945,993, which was a continuation application claiming priority benefit to a non-provisional patent application entitled “Improvement of an Aeroponic System and Method,” which was filed on Nov. 21, 2012, and assigned Ser. No. 13/683,700. The entire contents of the foregoing non-provisional patent applications are incorporated herein by reference.

### TECHNICAL FIELD

The present disclosure relates to improvements to aeroponic systems and methods and, in particular, to aeroponic systems/methods that include a cloth or fabric support/substrate that provides advantageous aeroponic functionality.

### BACKGROUND

Cloth and fabric materials have been implemented in a variety of industries. In connection with the widespread adoption and use of cloth, research has been undertaken to determine how various cloth materials function with respect to moisture. For example, research into how to move moisture away from the human body, e.g., during exercise promoting sweat, has been previously performed. This movement of moisture generally involves two components, absorption of the fabric and transmission of moisture post-saturation from a moisture layer adjacent to the fabric.

Additional research into absorption for cleaning and drying purposes, e.g., towels, wipes, and the like, has also been performed. In particular, this research generally focuses on dry and wet tenacity in grams/denier and water imbibition. Thus, these studies generally focus on absorbing and retaining moisture, rather than releasing moisture from a cloth/fabric substrate.

As is known in the industry, several studies have been performed to determine the absorption properties of cloth materials. (See, e.g., Das, B. et al., Moisture Flow Through Blended Fabrics—Effect of Hydrophilicity, Journal of Engineered Fibers and Fabrics, 4(4): 20-28 (2009); Varshney, R. K. et al., A Study on Thermophysiological Comfort Properties of Fabrics in Relation to Constituent Fibre Fineness and Cross-Sectional Shapes, J. Textile Institute, 101(6): 495-505 (2010); Tàpias, M. et al., Objective Measure of Woven Fabric's Cover Factor by Image Processing, Textile Res. J., 80(1): 35-44 (2010); Hearle, J. W. S., Capacity, Dielectric Constant, and Power Factor of Fiber Assemblies, Textile Res. J., 25: 307-321 (1954); Du, Y. et al., Polymolecular Layer Adsorption Model and Mathematical Simulation of Moisture Adsorption of Fabrics, Textile Res. J., 80(16): 1627-1632 (2010); Du, Y. et al., Dynamic Moisture Absorption Behavior of Polyester-Cotton Fabric and Mathematical Model, Textile Res. J., 80(17): 1793-1802 (2010); and Su, C. et al., Moisture Absorption and Release of Profiled Polyester and Cotton Composite Knitted Fabrics, Textile Res. J., 77(10): 764-769 (2007)). However, the absorption properties that have been investigated do not provide insight and/or guidance with respect to potential aeroponic farming applications and/or environments, e.g., environments where nutrient solution is constantly supplied to a cloth/fabric material. Exemplary aeroponic farming environments and systems are disclosed in U.S. Patent Publication No. 2011/0146146 entitled “Method and Apparatus for Aeroponic Farming,” filed on Dec. 10, 2010, the contents of which are incorporated herein by reference.

Thus, a need exists for improvements to aeroponic systems and methods to improve and/or enhance the performance of cloth/fabric materials for seed and plant support. More particularly, a need exists for aeroponic systems and methods that incorporate cloth and/or fabric materials that promote advantageous germination properties and plant yield. These and other needs are addressed by the systems and methods of the present disclosure.

### SUMMARY

In accordance with embodiments of the present disclosure, exemplary improvements relative to aeroponic systems and methods are provided that generally include a growth chamber, at least one of a light source, a nutrient solution source, and one or more cloth/fabric support elements. The improved aeroponic systems/methods also generally include cloth or fabric that is supported by the cloth/fabric support elements. The cloth/fabric is selected so as to promote advantageous germination properties and plant yield. Cloth/fabric materials that have been found to achieve advantageous results in aeroponic environments simultaneously satisfy two distinct and independent parameters, namely a wicking height parameter and an absorbance parameter, as described herein.

More particularly, it has been found according to the present disclosure that advantageous aeroponic results are achieved with cloth/fabric materials that simultaneously exhibit (i) a wicking height parameter characterized by a wicking height range from approximately 1.1 cm to approximately 4.5 cm, and (ii) an absorbance parameter characterized by an absorbance range of approximately 0.10 g/cm² to approximately 0.29 g/cm².

In some exemplary embodiments, the cloth or fabric can be selected from a group consisting of a polyester voile material, a PE from NCSU 1/150 High Energy material, a polar fleece tan 100 material, a polar fleece 300 material, a PE from NCSU 190 1/1 material, a PE from NCSU 2/150 High Energy material, a polar fleece 200 new material, a polar fleece 200 black material, a PE from NCSU 280 1/1 material, a polar fleece 200 used short time material, a polar fleece 200 used long time material, cloth or fabric materials exhibiting similar efficacy with or without a napped surface, and the like. In further exemplary embodiments, the cloth or fabric can be selected from, e.g., a polyester material, an acrylic material, a non-biodegradable synthetic material, cloth or fabric materials exhibiting similar efficacy, and the like, with or without a napped surface.

Generally, the wicking height parameter is a measurement of an ability of a cloth/fabric to absorb moisture, e.g., water, a nutrient solution, and the like. The absorbance parameter, in turn, is generally a measurement of moisture, e.g., water, a nutrient solution, and the like, that is retained by the cloth/fabric. Cloths/fabrics that exhibit a desired combination of wicking height/absorbance parameters are believed to result in advantageous aeroponic performance because of the nature of aeroponic farming applications. More particularly, in aeroponic applications, a cloth/fabric support or substrate generally functions in part to permit or facilitate root penetration. Further, the cloth/fabric support or substrate generally provides a barrier to nutrient solution spray from passing through the cloth/fabric when sprayed on at least one surface of the cloth.

Exemplary aeroponic systems and methods of the present disclosure generally satisfy one or more germination factors. The germination factors can be at least one of, e.g., a temperature range, a pH level range, a relative humidity range, a light intensity range, a light spectrum, an electrical conductivity range, seed treatments such as scarification, prior heating or cooling, and the like. The temperature range can be from approximately 5° C. to approximately 35° C. The pH level range can be from approximately 4 to approximately 8. The relative humidity range can be from approximately 20% to approximately 100%. The light intensity range can be from approximately 0 μmol·m⁻²·s⁻¹ to approximately 250 μmol·m⁻²·s⁻¹. The light spectrum can be from approximately 400 nm to approximately 700 nm with some tolerance in the UV-B radiation, e.g., approximately 280 nm to approximately 315 nm. The electrical conductivity range can be from approximately 1.5 dS·m⁻¹ to approximately 3.0 dS·m⁻¹. For some seeds, a photoperiodism may exist which requires both light and dark periods. In some exemplary embodiments, e.g., for some cold season leafy greens (such as Eruca sativa), a preferred temperature can be approximately 22° C., the pH level range can be from approximately 5.0 to approximately 5.5, the electrical conductivity range can be from approximately 2.0 dS·m⁻¹ to approximately 2.5 dS·m⁻¹, and the relative humidity can be approximately 50%. In some exemplary embodiments, e.g., some cold season leafy greens, the light intensity during germination can be approximately 50 μmol·m⁻²·s⁻¹ and approximately 250 μmol·m⁻²·s⁻¹ during the baby stage of maturity. Once a plant has emerged, up to approximately 1000 ppm of CO₂ may be applied for advantageous growth. In some exemplary embodiments, the light spectrum after germination can be approximately 440 nm blue and approximately 660 nm red. However, it should be understood that the exemplary ranges provided herein may be varied depending on the requirements and/or optimal environments for germinating and growing alternative seeds or plants.

The cloth/fabric is generally configured and dimensioned to support seeds thereon. The cloth/fabric supported by the cloth/fabric support elements generally inhibits puddling of a nutrient solution on the cloth/fabric by maintaining the cloth/fabric in a substantially flat and/or stretched orientation. The exemplary cloth/fabric can be at least one of a napped material and a non-napped material. Napping associated with the disclosed cloth/fabric may be uniformly or non-uniformly dispersed or distributed across the surface(s) of the cloth/fabric. However, the exemplary cloth/fabric generally should not define an upwardly directed nap on a surface supporting seeds thereon.

In accordance with embodiments of the present disclosure, exemplary improvements to methods of aeroponic farming are also provided, wherein an aeroponic system is utilized that includes, inter alia, a growth chamber and cloth/fabric support elements. The exemplary method generally includes supporting a cloth/fabric with the cloth/fabric support elements. The cloth/fabric simultaneously exhibits (i) a wicking height parameter characterized by a wicking height range from approximately 1.1 cm to approximately 4.5 cm, and (ii) an absorbance parameter characterized by an absorbance range of approximately 0.10 g/cm² to approximately 0.29 g/cm². The exemplary method generally includes depositing seeds on the cloth/fabric. Further, the exemplary method generally includes spraying a nutrient solution on at least one surface of the cloth/fabric.

In accordance with embodiments of the present disclosure, exemplary systems for farming are provided that generally include a growth chamber and a cloth or fabric positioned within the growth chamber. The cloth or fabric generally exhibits a wicking height parameter characterized by a wicking height range from approximately 0.6 cm to approximately 8.1 cm. The cloth or fabric generally also exhibits an absorbance parameter characterized by an absorbance range from approximately 0.10 g/cm² to approximately 0.29 g/cm².

The wicking height parameter can be a measurement of an ability of the cloth or fabric to absorb moisture. The absorbance parameter can be a measurement of moisture the cloth or fabric retains. The cloth or fabric generally facilitates root penetration, provides controlled access to moisture, e.g., a nutrient solution, water, and the like, and can be configured and dimensioned to support seeds and plants thereon. In some exemplary embodiments, the cloth or fabric can inhibit puddling of a nutrient solution on the cloth or fabric. The cloth or fabric can be selected from a group consisting of, e.g., a polyester material, an acrylic material, a non-biodegradable synthetic material, and the like, with or without napping. In some exemplary embodiments, the cloth or fabric does not define an upwardly directed nap on a surface supporting seeds thereon.

The exemplary systems generally include at least one of cloth or fabric support elements, a light source and a nutrient solution source. Exemplary systems of the present disclosure generally satisfy one or more germination factors. The germination factors can be at least one of, e.g., a temperature range, a pH level range, a relative humidity range, a light intensity range, a light spectrum, an electrical conductivity range, seed treatments such as scarification, prior heating or cooling, and the like. The temperature range can be from approximately 5° C. to approximately 35° C. The pH level range can be from approximately 4 to approximately 8. The relative humidity range can be from approximately 20% to approximately 100%. The light intensity range can be from approximately 0 μmol·m⁻²·s⁻¹ to approximately 250 μmol·m⁻²·s⁻¹. The light spectrum can be from approximately 400 nm to approximately 700 nm with some tolerance in the UV-B radiation, e.g., approximately 280 nm to approximately 315 nm. The electrical conductivity range can be from approximately 1.5 dS·m⁻¹ to approximately 3.0 dS·m⁻¹. For some seeds, a photoperiodism may exist which requires both light and dark periods. In some exemplary embodiments, e.g., for some cold season leafy greens (such as Eruca sativa), a preferred temperature can be approximately 22° C., the pH level range can be from approximately 5.0 to approximately 5.5, the electrical conductivity range can be from approximately 2.0 dS·m⁻¹ to approximately 2.5 dS·m⁻¹, and the relative humidity can be approximately 50%. In some exemplary embodiments, e.g., some cold season leafy greens, the light intensity during germination can be approximately 50 μmol·m⁻²·s⁻¹ and approximately 250 μmol·m⁻²·s⁻¹ during the baby stage of maturity. Once a plant has emerged, up to approximately 1000 ppm of CO₂ may be applied for advantageous growth. In some exemplary embodiments, the light spectrum after germination can be approximately 440 nm blue and approximately 660 nm red. However, it should be understood that the exemplary ranges provided herein may be varied depending on the requirements and/or optimal environments for germinating and growing alternative seeds or plants.

In accordance with embodiments of the present disclosure, exemplary methods of farming are provided that generally include providing a system for farming that includes a growth chamber. The exemplary methods generally include supporting a cloth or fabric within the growth chamber. The cloth or fabric generally exhibits a wicking height parameter characterized by a wicking height range from approximately 0.6 cm to approximately 8.1 cm. The cloth or fabric generally also exhibits an absorbance parameter characterized by an absorbance range from approximately 0.10 g/cm² to approximately 0.29 g/cm².

The exemplary methods generally include depositing seeds on the cloth or fabric and germinating the seeds by at least one of, e.g., spraying a nutrient solution on at least one surface of the cloth or fabric, submerging the cloth or fabric into the nutrient solution, and the like. In general, the methods include supporting plant growth on the cloth or fabric by spraying the nutrient solution on at least one surface of the cloth or fabric.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed systems and methods, reference is made to the accompanying figures, wherein:

FIGS. 1A-1C show an exemplary aeroponic system utilized in conjunction with exemplary cloth or fabric materials;

FIG. 2 shows a photograph of sample A, an exemplary polar fleece (200), used for a long time (e.g., about 5 years), cloth material;

FIG. 3 shows a photograph of sample B, an exemplary polar fleece (200), used for a short time (e.g., less than about 3 months), cloth material;

FIG. 4 shows a photograph of sample C, an exemplary new polar fleece (200) cloth material;

FIG. 5 shows a photograph of sample D, an exemplary tan polar fleece (100) cloth material;

FIG. 6 shows a photograph of sample E, an exemplary black polar fleece (200) cloth material;

FIG. 7 shows a photograph of a non-napped side of sample F, an exemplary polyester (PE) from the North Carolina State University Department of Textiles (NCSU) 5.6A 2/2 cloth material;

FIG. 8 shows a photograph of a napped side of sample F, an exemplary PE from NCSU 5.6A 2/2 cloth material;

FIG. 9 shows a photograph of a non-napped side of sample I, an exemplary PE from NCSU 190 1/1 cloth material;

FIG. 10 shows a photograph of a napped side of sample I, an exemplary PE from NCSU 190 1/1 cloth material;

FIG. 11 shows a photograph of a non-napped side of sample J, an exemplary PE from NCSU 280 1/1 cloth material;

FIG. 12 shows a photograph of a napped side of sample J, an exemplary PE from NCSU 280 1/1 cloth material;

FIG. 13 shows a photograph of a non-napped side of sample K₁, an exemplary PE from NCSU 2/150 High Energy (HE) cloth material;

FIG. 14 shows a photograph of a napped side of sample K₁, an exemplary PE from NCSU 2/150 HE cloth material;

FIG. 15 shows a photograph of a non-napped side of sample K₂, an exemplary PE from NCSU 2/150 HE cloth material;

FIG. 16 shows a photograph of a napped side of sample K₂, an exemplary PE from NCSU 2/150 HE cloth material;

FIG. 17 shows a photograph of a non-napped and a napped side of sample L₁, an exemplary PE from NCSU 1/150 HE cloth material;

FIG. 18 shows a photograph of a non-napped and a napped side of sample L₂, an exemplary PE from NCSU 1/150 HE cloth material;

FIG. 19 shows a photograph of a non-napped side of sample M, an exemplary PE from NCSU 2/150 cloth material;

FIG. 20 shows a photograph of a napped side of sample M, an exemplary PE from NCSU 2/150 cloth material;

FIG. 21 shows a photograph of sample N, an exemplary recycled pop bottle fiber cloth material;

FIG. 22 shows a photograph of sample O, an exemplary polar fleece 300 cloth material;

FIG. 23 shows a photograph of sample P₁, an exemplary shade cloth material;

FIG. 24 shows a photograph of sample P₂, an exemplary sheer shade cloth material;

FIG. 25 shows a photograph of a non-napped side of sample Q, an exemplary polyester voile (prototype) cloth material;

FIG. 26 shows a photograph of a napped side of sample Q, an exemplary polyester voile (prototype) cloth material;

FIG. 27 shows a photograph of a non-napped side of sample R, an exemplary thin polyester voile (prototype) cloth material;

FIG. 28 shows a photograph of a napped side of sample R, an exemplary thin polyester voile (prototype) cloth material;

FIG. 29 shows a photograph of sample S₁, an exemplary cotton cloth material;

FIG. 30 shows a photograph of sample S₂, an exemplary cotton cloth material;

FIG. 31 shows a photograph of sample S₃, an exemplary cotton cloth material;

FIG. 32 shows a photograph of sample T, an exemplary white spandex cloth material;

FIG. 33 shows a photograph of a non-napped side of sample V, an exemplary PE from NCSU 4/1 cloth material;

FIG. 34 shows a photograph of a napped side of sample V, an exemplary PE from NCSU 4/1 cloth material;

FIG. 35 shows an exemplary experimental set-up for Experiment 1;

FIGS. 36A and 36B show exemplary diagrams for first and second flats for Experiments 2, 3 and 4;

FIG. 37 shows a photograph of an exemplary first flat as implemented in Experiments 2, 3 and 4;

FIG. 38 is a graph of exemplary light intensity conditions in a growth chamber;

FIG. 39 is a graph of exemplary temperature, pH level and electrical conductivity conditions in a growth chamber for Experiment 3; and

FIG. 40 is an additional graph of exemplary temperature, pH level and electrical conductivity conditions in a growth chamber for Experiment 4.

### DESCRIPTION OF EXEMPLARY EMBODIMENTS

Advantageous aeroponic systems and methods are described in U.S. Patent Publication No. 2011/0146146, entitled “Method and Apparatus for Aeroponic Farming,” filed on Dec. 10, 2010 (previously incorporated herein by reference). The '146 publication teaches the benefit of cloth materials in the context of aeroponic systems. However, further research and experimentation has been undertaken to assess the types of cloth/fabric materials that may support aeroponic applications to a greater extent than other cloth/fabric materials. In particular, it is noted that in prior disclosures the description of cloth has been based on such physical properties as yarn size, fiber composition, weave, napping, and the like. These typical physical properties have been found to be of limited value in predicting the performance of cloth/fabric materials in aeroponic systems/methods. To the contrary and according to the present disclosure, advantageous cloth/fabric materials for use in aeroponic systems/methods are identified independent of such typical physical properties, but instead based on two (2) distinct parameters as described herein, namely a wicking height parameter and an absorbance parameter.

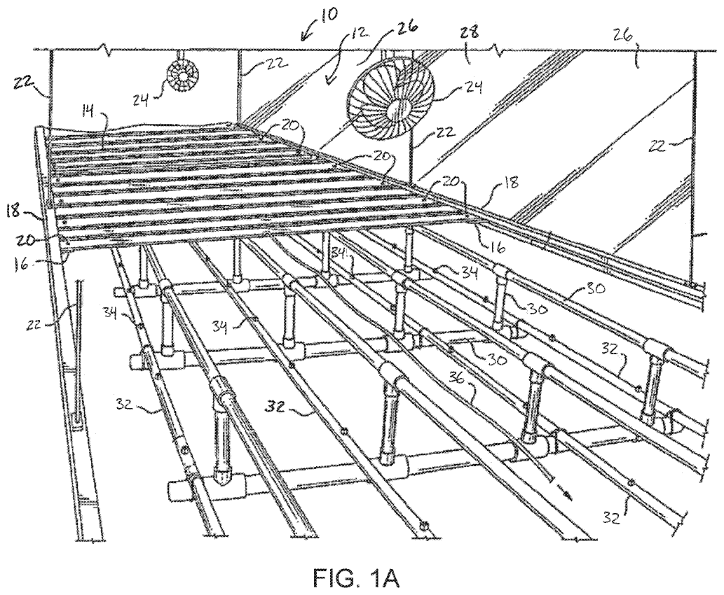

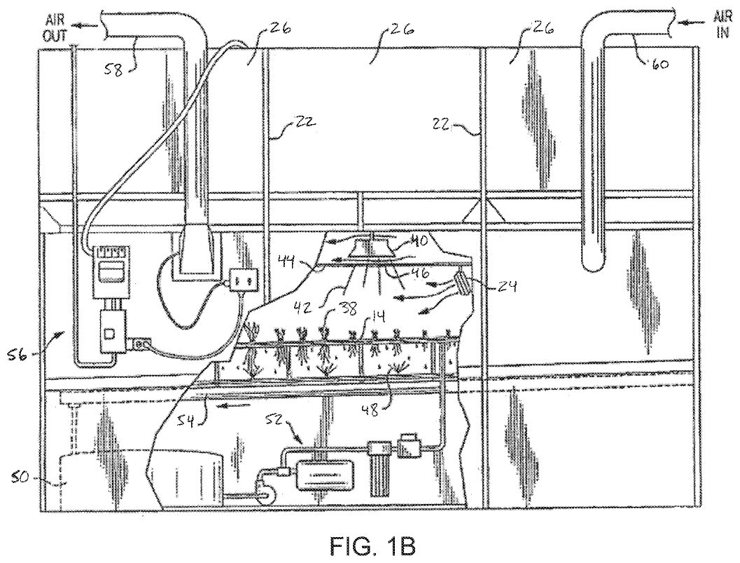

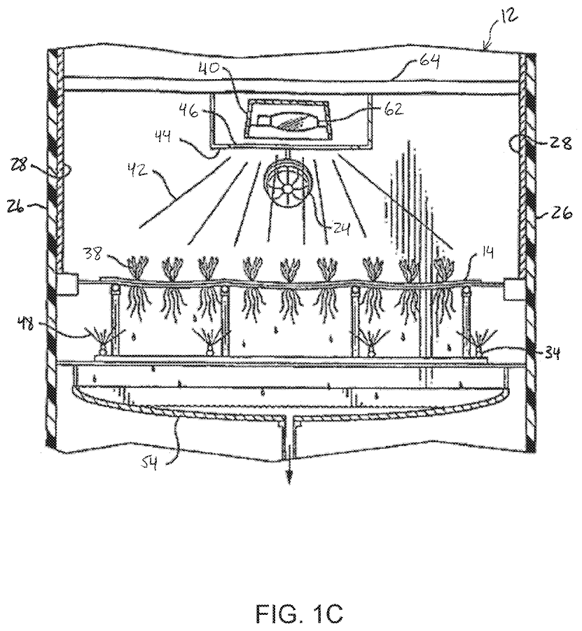

Exemplary aeroponic systems to be implemented with the advantageous cloth/fabric materials described herein are illustrated in FIGS. 1A-C. The exemplary aeroponic systems generally include a growth chamber 10 with at least one aeroponic module 12. Flats 14, e.g., strips of exemplary cloth material sewn together, may be attached to trolleys 16 via trolley rails 18 with fastening snaps 20 and corresponding trolley snap studs (not shown), thereby maintaining flats 14 in a substantially taut configuration. Flats 14 may be advanced through the growth chamber 10, e.g., manually, automatically, and the like. In some exemplary embodiments, the advancement of the flats 14 may be performed with a rope 36. In some exemplary embodiments, a single piece of fabric can be fitted with grommets used to attach the fabric to a frame which has cross members to support the cloth, these trays can be implemented for seeding and harvesting, and these trays can be set on rails on each side of the chamber 10 and pulled along as they are linked together like a chain. The speed of advancement generally depends on the growth rate of the plants 38 being grown in flats 14 and may be a slow continuous advancement or a periodic advancement. As flats 14 reach an end of the growth chamber 10, an automated cutting apparatus (not shown) may be implemented to cut the plants 38, with the cut plants 38 dropping down into a collection chute (not shown), which in turn can lead to a bagging apparatus (not shown) for bagging the produce in a market-ready container. A series of modules 12 can be placed end-to-end to extend the total length of growth chamber 10. Depending on space, modules 12 and/or series of modules 12 can be stacked on one another, i.e., forming one growth chamber 10 over another growth chamber 10, such as is shown in FIG. 1C as module 12. The use of multiple growth chambers 10 may allow for tailoring of each grown chamber 10 to the specific needs of the plants being grown therein, e.g., light, temperature, nutrient composition, delivery, space, and the like.

A roof 64 (FIG. 1C) of each growth chamber 10 is preferably reflective and insulating, while a floor of each growth chamber 10 is preferably of a strong material which can be welded and shaped to form a trough, e.g., a high molecular weight polyethylene (HMWPE), stainless steel, and the like. The purpose of the growth chamber 10 can generally be to enable management of chamber temperature, humidity, and carbon dioxide. For smaller systems, such management is preferably done within a module 12 or series of modules 12. However, there is no theoretical limitation on the size of the growth chamber 10, and in fact, an entire building or warehouse could be used as one large growth chamber 10.

Trolley rails 18 can be supported by the framework composed of a plurality of framing members 22 and a plurality of side panels 26. Framing members 22 are preferably of an angled material such as an angle dimensioned to support side panels 26 and roof panel 64. A plurality of tubes 30 can be connected in a framework to provide support for flats 14 as they become weighed down by moisture or growing plants 38. Tubes 30 are preferably fabricated from PVC, but can be of any rust-proof material that is strong enough to support the weight of flats 14 when they are fully loaded with plants 38. A plurality of tubes 32, preferably of PVC, can be used to transport a nutrient solution from a nutrient tank 50 (FIG. 1B) as pumped by a nutrient pumping system 52 to a plurality of spray nozzles 34. The spray nozzles 34, in turn, can spray a nutrient spray 48 onto the bottom of flats 14, where the nutrient solution provides the necessary nutrients to the growing plants 38. Excess nutrient solution preferably drips down onto a nutrient return tray 54, which can return the nutrient solution to nutrient tank 50 for reuse. Nutrient return tray 54 can be a sheet of plastic, e.g., HMWPE, and the like, connected to horizontal framing members 22. A cross-section of nutrient return tray 54 is preferably arcuate in shape. Although a closed system is described herein, the exemplary cloth materials can optionally be implemented in a flow to drain system, i.e., an aeroponic system without reusing the excess nutrient solution.

Side panels 26 can be lined with a lining 28 to increase reflectivity of light 42 produced by a plurality of grow lamps 62 inside a duct 44 with a window 46 under each grow lamp 62. In some exemplary embodiments, rather than positioning the grow lamps 62 inside the duct 44, the grow lamps 62 may be positioned inside, e.g., the growth chamber 10, water jackets (not shown), and the like. In general, a grow lamp 62 can be any lamp, light, or series of lights, or mechanism for piping light in from outside the growth chamber 10, or mechanism for piping sunlight into the growth chamber, as long as the light is effective to promote photosynthesis in plants 38. Grow lamps 62 may be controlled by a controller (not shown) which controls the intensity, timing, spectrum, number of lamps, or any combination of these variables. Reflectors 40 may be implemented as they both increase light available and manage the light pattern. A plurality of fans 24 can provide air circulation within module 12, while a separate air movement system for cooling grow lamps 62 can include an air intake 60, duct 44, an air exhaust 58, and a fan (not shown) for the air movement within duct 44 controlled by an electrical control panel 56. The plurality of fans 24 generally provide sufficient turbulence to disturb the microenvironment of the plants, making CO₂ more accessible and moisture less confining. In some exemplary embodiments, rather than utilizing a plurality of fans 24 throughout the chamber 10, one large fan (not shown) may be positioned at an end of each chamber 10 to provide sufficient airflow, e.g., about 50 fpm, thereby accomplishing a substantially similar effect as the plurality of fans 24 with less equipment. Carbon dioxide (CO₂) may be controlled by introducing outside air to replenish what plans remove while growing, providing combustion devices that give off CO₂ or by using CO₂ from a tank (not shown) and distributing the CO₂ within the chamber 10.

With respect to terminology used herein in reference to the exemplary cloth/fabric materials, absorption and adsorption generally define different characteristics. Absorption generally refers to taking in or sucking up a liquid. In contrast, adsorption generally refers to gathering of liquid on a surface in a condensed layer. In general, cloth and/or fabric absorbs as a result of yarn adsorbing. Hygroscopicity generally refers to absorbance of liquid with a slight change in volume and can be applicable to fibers like cotton. It should be noted that hygroscopicity is generally not the same as the capillary action of a polyester fabric where no change in fiber volume occurs as the liquid fills pores. Water imbibition may also be used to reference absorbing or soaking up as a percentage, i.e., functionally the same as absorption.

In general, requirements for a cloth/fabric for growing plants in an aeroponic context include: (i) facilitation of root penetration to obtain access to nutrients sprayed from below; (ii) providing a barrier to nutrient spray reaching plant leaves; (iii) optimal conditions for germination; (iv) providing support for seeds and/or plants during germination and plant growth; and (v) ability to survive multiple growth and/or cleaning stages. Root penetration can generally be successful with respect to most cloth/fabric materials with different weaves and yarns. It has been determined that the point where weave, nap or fabric density fails to prevent the nutrient solution from accessing plant shoots should be avoided as it generally promotes disease on plant shoots. Although the composition of yarn may be important, the majority of cloth/fabric materials, except for polyester and acrylic, generally deteriorate rapidly prior to any meaningful plant yield. Napping can be advantageous as it facilitates moisture to seeds and/or enhances prevention of nutrient access to shoots where looser weaves are utilized.

In the majority of hydroponic operations, it should be noted that plant tissue exposed to nutrient solution generally deteriorates rapidly. This is believed to result from the naturally developing rich biome of microorganisms that develops in the nutrient solution and is capable of attacking and/or digesting plant tissues. Roots are generally resistant to the organisms in this biome and some evidence exists for enhanced plant uptake of nutrients due to this biome. In some hydroponic systems, a means may be provided to separate the plant from the root and/or nutrient zone.

Observation of a “club” with a multitude of root divisions above the cloth/fabric surface in the shoot stem/root interface may be detrimental to the plant and may be addressable with weave. Removal and/or reduction of the club would generally result in improved yield due to accelerated penetration and fewer root divisions required during penetration. However, the cloth/fabric material should still prevent the nutrient solution from entering the plant area above the cloth/fabric.

In addition to the preferred cloth/fabric properties for growing plants described above, additional considerations are noteworthy. For example, if the moisture level is too high near the growing plant roots, an inviting environment is created for fungi. This condition thereby applies an upper limit to absorptive capacity and/or horizontal wicking where the result can be excessive nutrient solution. The condition of high moisture levels has been observed where the cloth/fabric is not stretched sufficiently by cloth/fabric supporting elements, thus creating low spots where puddling of nutrient solution may occur irrespective of the absorbance and wicking properties. A majority of seed varieties completely submersed in the nutrient solution on the cloth/fabric surface due to puddling generally drown. As such, the cloth/fabric material should be maintained in a sufficiently taut orientation by the cloth/fabric supporting elements to substantially prevent puddling. The rate of nutrient solution replenishment, e.g., large droplets, a dense mist, soaking, and the like, can also be varied to prevent puddling on the cloth/fabric. In some exemplary embodiments, the rate of application of the nutrient solution can be varied to provide preferable germination and growing environments, e.g., higher dampness initially for germination and lower dampness post-germination to reduce a fungal habitat. In further exemplary embodiments, the germination process may be performed outside of an aeroponic growth chamber, e.g., a cloth soaking process in a pan.

Germination generally requires hydration of the seed coating to allow emergence of the radical (initial root) and subsequent shoot. Other non-cloth related conditions, e.g., light intensity levels, temperature levels, pH levels, seed preparation based on the plant variety, and the like, should also be selected so as to influence and/or enhance overall success of germination.

Additional investigations have generally determined that an optimal density of plants may be required for maximum yield. This density can generally be dependent on plant germination. Further, plants should grow rapidly to achieve maximum economic results and/or to reduce algal growth. The growth of algae can generally be dependent on light. A rapid and complete plant canopy may be implemented to remove light necessary for algal growth, which is generally undesirable as it creates a potential contaminant during harvest.

The properties and/or parameters discussed above generally emphasize the need for complete and rapid germination of seeds. However, as detailed herein, proper selection of a cloth/fabric to support seed germination and plant growth in an aeroponic system/method offers a substantial opportunity to enhance overall aeroponic performance. Indeed, as demonstrated herein, (i) cloth/fabric that is too open, thereby allowing nutrient solution to escape above the cloth/fabric or to soak the cloth/fabric and/or allowing seeds to fall through, is generally not preferred for an aeroponic system, (ii) cloth/fabric that does not hold sufficient moisture may cause germination to be slow or may prevent germination completely, and (iii) cloth/fabric that holds the proper moisture for rapid germination without disease is generally desired. Accordingly, the present disclosure shows that wicking and absorbance characteristics of cloth/fabric may be used to select optimal cloth/fabric materials for use in aeroponic systems.

Experimental Protocols

The ability of a cloth/fabric material to provide moisture to the seed coating persistently without drowning the seed, thereby optimizing seed germination, can generally be specified by absorbance parameters. In addition, wicking parameters may be used to measure the travel of moisture relative to a cloth/fabric and may correlate with seed germination behavior. The following testing protocols unexpectedly demonstrated the existence of an optimal combination of absorbance and wicking parameters for optimally germinating seeds and yielding desired plant life in aeroponic applications.

Experiment 1

The first experiment investigated two parameters related to absorbance: (i) how well will a cloth/fabric wick water, and (ii) how much water will a particular cloth/fabric retain, i.e., absorptive capacity. The relationship between these two parameters was also determined. The first experiment focused on determining the preferred range for parameters, what cloth/fabric characteristics may influence absorbance, and to narrow cloth/fabric selections for subsequent germination trials.

Based on the cloth/fabric investigations in the industry described above, cotton was expected to outperform polyester, except that its organic nature would have it decay rapidly when covered with nutrient solution. It should be noted that polyester with napping (similar to polar fleece) generally performs well by design in both wicking and absorbance. It may be concluded that yarn density and material, napping or similar treatment, and weave generally impact absorbance and/or wicking. Since warp and weft in the prior investigations caused only slight differences in wicking, these parameters were generally not taken into account in Experiment 1.

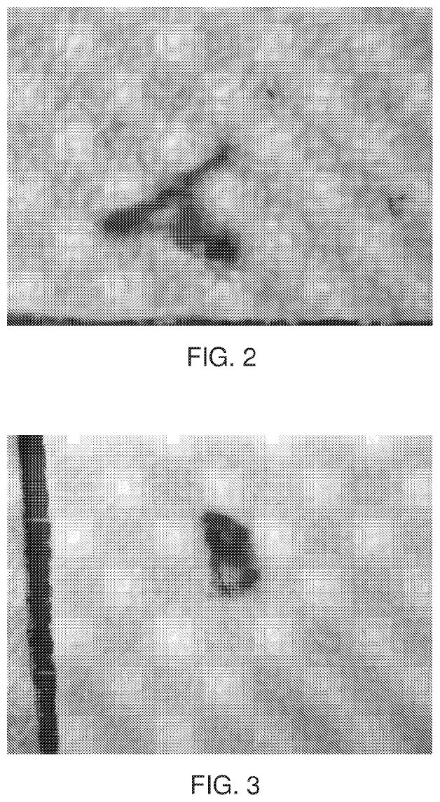

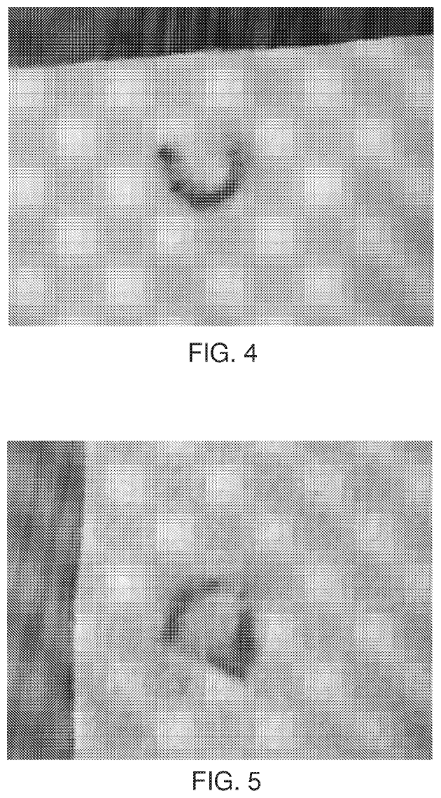

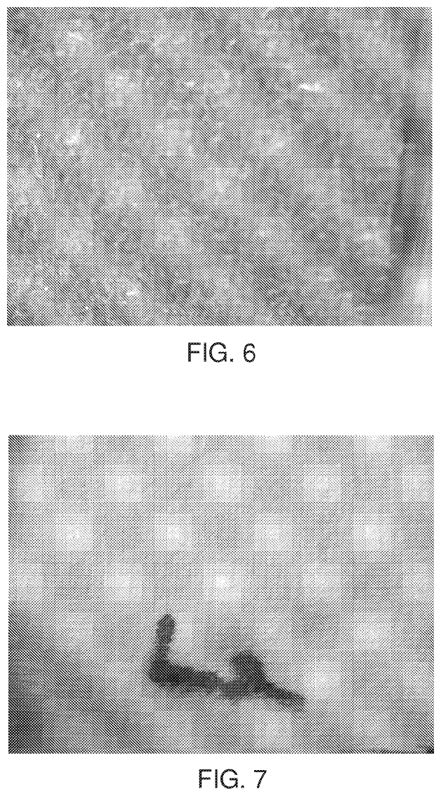

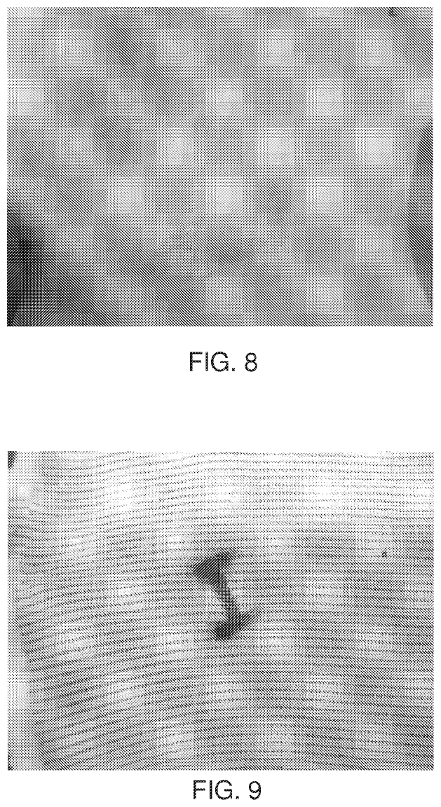

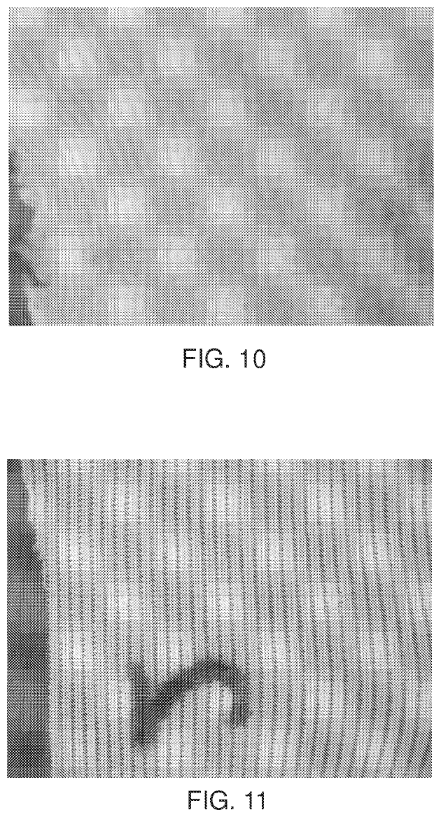

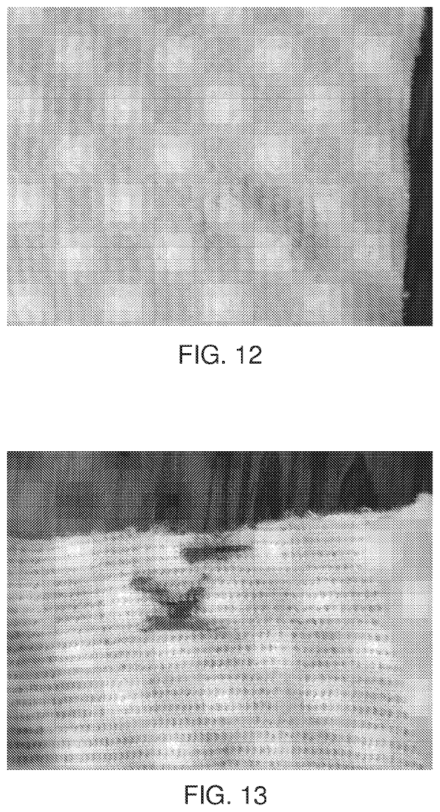

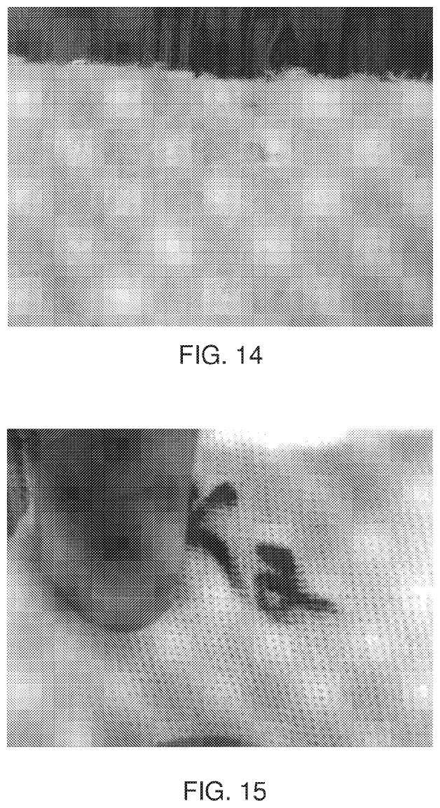

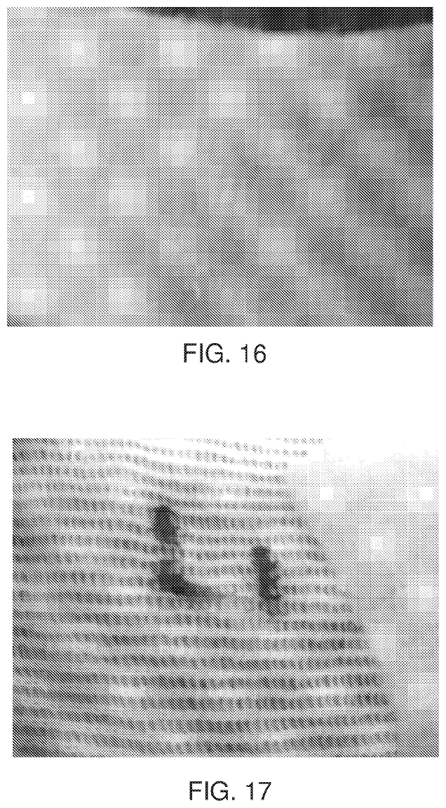

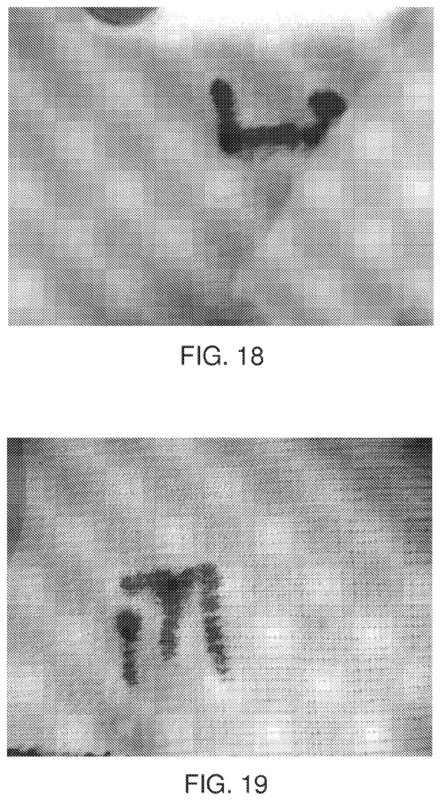

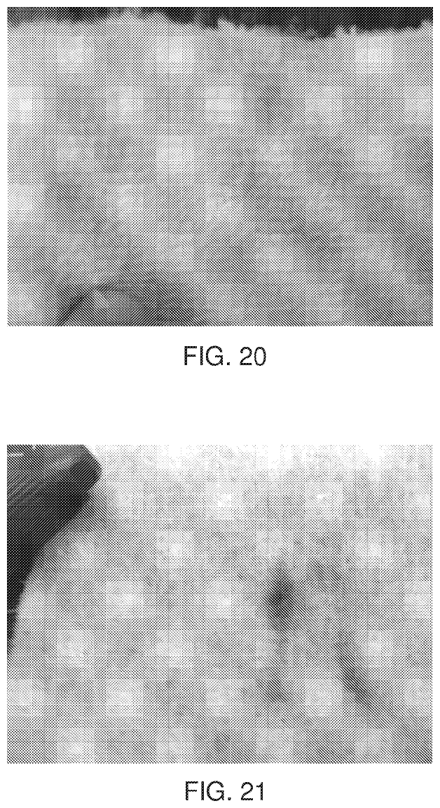

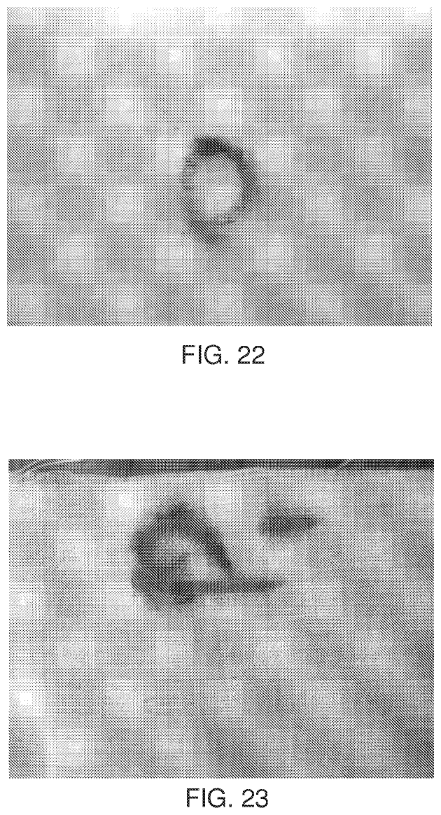

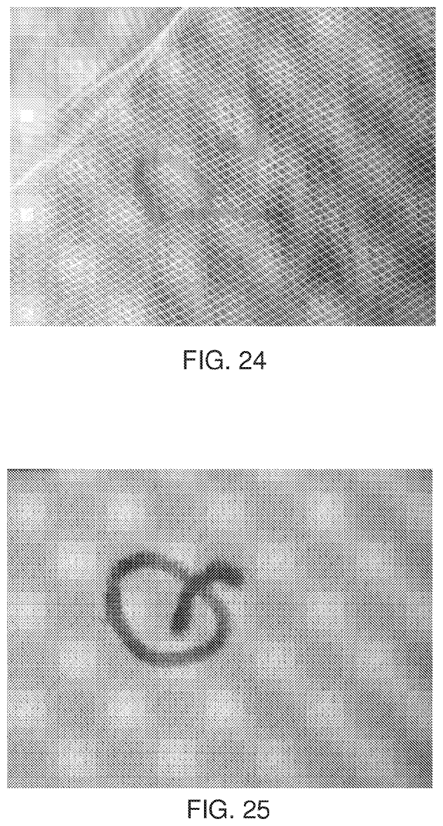

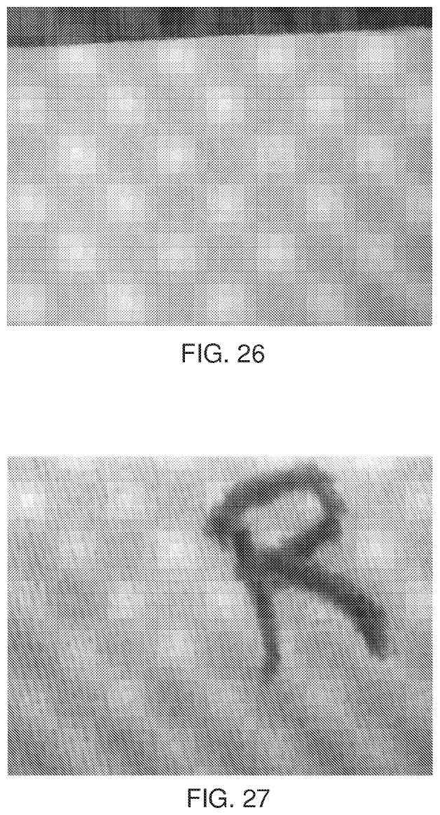

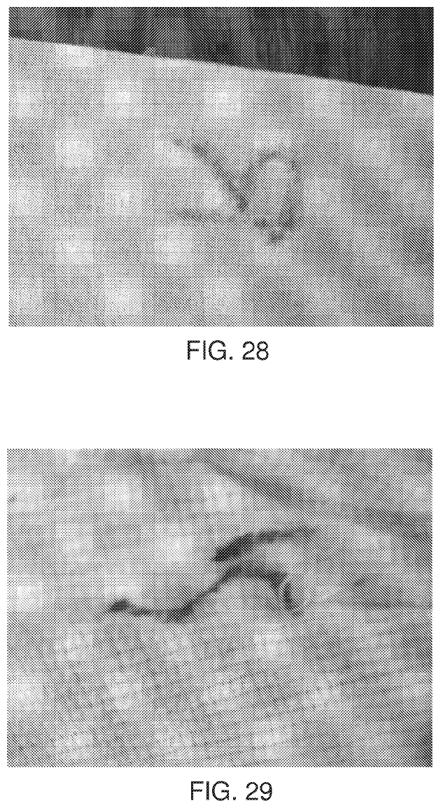

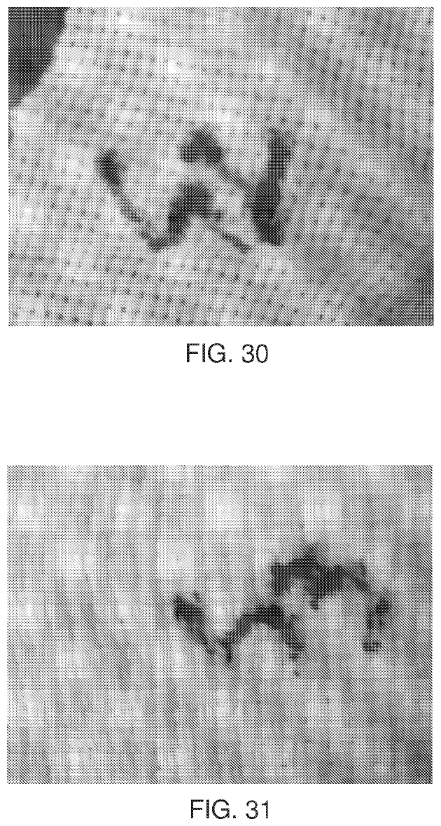

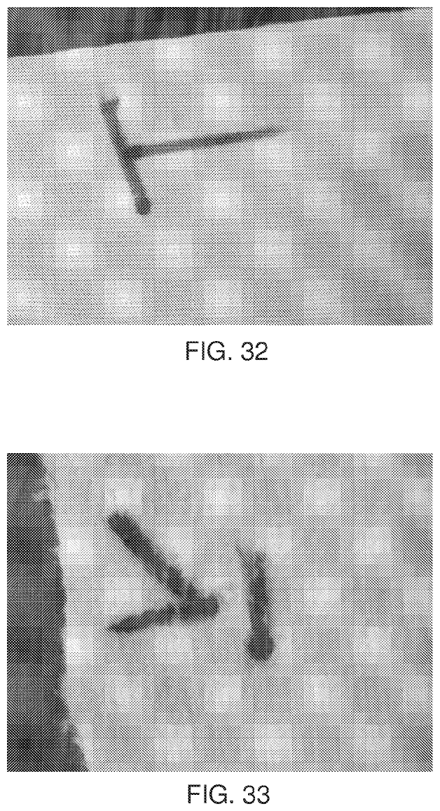

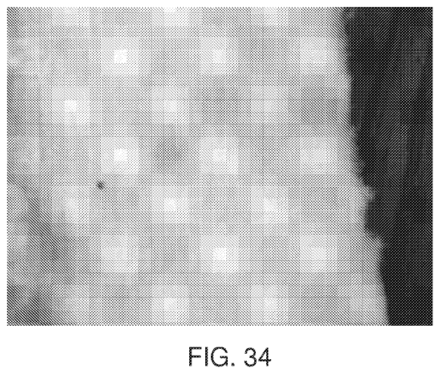

A variety of cloth/fabric samples were collected over time. FIGS. 2-34 show close-up photographs of each cloth/fabric sample tested. In particular, FIG. 2 shows sample A, an exemplary polar fleece (200), used for a long time (e.g., about 5 years), cloth material; FIG. 3 shows sample B, an exemplary polar fleece (200), used for a short time (e.g., less than about 3 months), cloth material; FIG. 4 shows sample C, an exemplary new polar fleece (200) cloth material; FIG. 5 shows sample D, an exemplary tan polar fleece (100) cloth material; FIG. 6 shows sample E, an exemplary black polar fleece (200) cloth material; FIG. 7 shows a non-napped side of sample F, an exemplary PE from NCSU 5.6A 2/2 cloth material; FIG. 8 shows a napped side of sample F, an exemplary PE from NCSU 5.6A 2/2 cloth material; FIG. 9 shows a non-napped side of sample I, an exemplary PE from NCSU 190 1/1 cloth material; FIG. 10 shows a napped side of sample I, an exemplary PE from NCSU 190 1/1 cloth material; FIG. 11 shows a non-napped side of sample J, an exemplary PE from NCSU 280 1/1 cloth material; FIG. 12 shows a napped side of sample J, an exemplary PE from NCSU 280 1/1 cloth material; FIG. 13 shows a non-napped side of sample K₁, an exemplary PE from NCSU 2/150 HE cloth material; FIG. 14 shows a napped side of sample K₁, an exemplary PE from NCSU 2/150 HE cloth material; FIG. 15 shows a non-napped side of sample K₂, an exemplary PE from NCSU 2/150 HE cloth material; FIG. 16 shows a napped side of sample K₂, an exemplary PE from NCSU 2/150 HE cloth material; FIG. 17 shows a non-napped and a napped side of sample L₁, an exemplary PE from NCSU 1/150 HE cloth material; FIG. 18 shows a non-napped and a napped side of sample L₂, an exemplary PE from NCSU 1/150 HE cloth material; FIG. 19 shows a non-napped side of sample M, an exemplary PE from NCSU 2/150 cloth material; FIG. 20 shows a napped side of sample M, an exemplary PE from NCSU 2/150 cloth material; FIG. 21 shows sample N, an exemplary recycled pop bottle fiber cloth material; FIG. 22 shows sample O, an exemplary polar fleece 300 cloth material; FIG. 23 shows sample P₁, an exemplary shade cloth material; FIG. 24 shows sample P₂, an exemplary sheer shade cloth material; FIG. 25 shows a non-napped side of sample Q, an exemplary polyester voile (prototype) cloth material; FIG. 26 shows a napped side of sample Q, an exemplary polyester voile (prototype) cloth material; FIG. 27 shows a non-napped side of sample R, an exemplary thin polyester voile (prototype) cloth material; FIG. 28 shows a napped side of sample R, an exemplary thin polyester voile (prototype) cloth material; FIG. 29 shows sample S₁, an exemplary cotton cloth material; FIG. 30 shows sample S₂, an exemplary cotton cloth material; FIG. 31 shows sample S₃, an exemplary cotton cloth material; FIG. 32 shows sample T, an exemplary white spandex cloth material; FIG. 33 shows a non-napped side of sample V, an exemplary PE from NCSU 4/1 cloth material; and FIG. 34 shows a napped side of sample V, an exemplary PE form NCSU 4/1 cloth material.

As referenced herein, High Energy (HE) refers to a high speed of knitting, which generally creates a tighter and/or narrower cloth or fabric. Samples K₁, K₂, L₁ and L₂, respectively, were substantially similar with minor differences in HE levels and/or the number of passes on a napper. Samples S₁, S₂ and S₃ generally defined different weaves and/or yarn sizes and differed by weight of the overall fabric. Sufficient cloth remained of some samples to create flats for Experiment 2, as will be described below. In prior investigations, a specific time was generally used for drainage post-moistening to determine the absorptive capacity. In Experiment 1, when a drop took more than five seconds from its predecessor to fall from the cloth, the weight of the cloth was recorded.

Prior to performing Experiment 1, initial experiments were performed to assess ranges, variables, setup and apparatus requirements. Based on the notion that wicking required cloth to be slipped into a liquid with subsequent measurement of the height of the liquid, tap water was utilized for ease of repeatability and a tub was fitted with its lid cut to accommodate a clip for holding strips of cloth materials. The strips of cloth material were then placed in the liquid. Food coloring, e.g., approximately 1 teaspoon/liter, was added to the liquid to aid in determination of the height of the liquid. The apparatus was tested with a plurality of cloth strips and several observations were made. The dye generally tended to settle in the tub. The napping of a cloth could disguise the height and utilizing a screw driver to press the nap was not a satisfactory solution. Cloth strips generally dripped at varying rates and/or amounts after dunking and the preferred cloth strips generally wicked to the top of the test strip in less than about 10 seconds. However, a time factor was needed to be considered in wicking, the need for a standard for dripping post-removal from dunking in solution to perform weighing existed, a better tool was needed to manage napping, and a scale capable of precisely measuring low weights was desired.

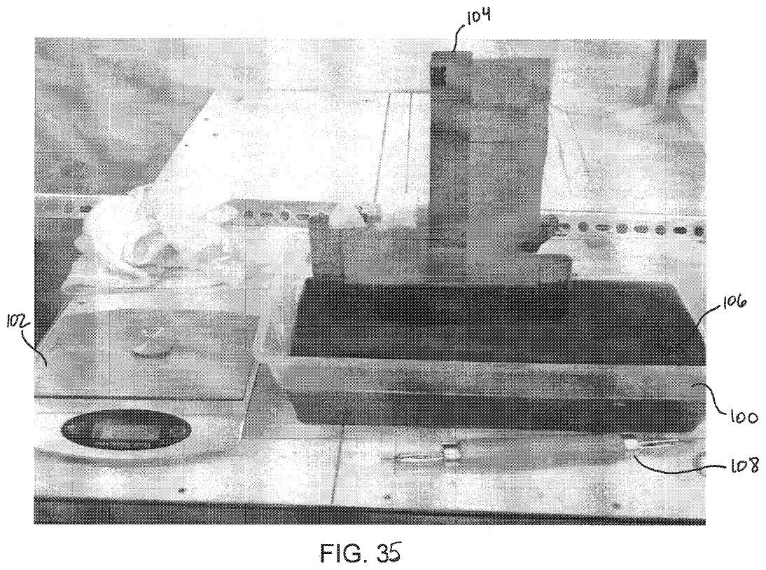

For Experiment 1, a soaking pan was filled with water and a small amount of red food coloring (e.g., food coloring including water, glycerin, FD&C red 40, citric acid, and sodium benzoate). The pH level was measured at approximately 7.6, the water temperature was measured at approximately 13.5° C., and the electrical conductivity was measured at approximately 0.42 dS/m. The air was measured at approximately 57% relative humidity and approximately 19.5° C. FIG. 35 shows the experimental set-up for Experiment 1, including the soaking pan 100 filled with a red dye mixture 106, a scale 102, a ruler 104, and a spline roller 108.

A goal of Experiment 1 was to determine the value of wicking and the value of absorption separately. A strip measuring approximately 1 inch by 3.5 inches was cut for each cloth tested. The exemplary cloth materials tested are listed in the Tables below. Two strips were placed on clips and were dropped at the same time into the soaking pan 100. It was desired that water would be absorbed and retained by the cloth while spreading evenly. The wick height was measured at approximately 3 minutes and approximately 6 minutes after dropping. The strips of cloth were allowed to soak in the soaking pan 100, removed from the soaking pan 100 and allowed to drip, i.e., drops were allowed to drip off each cloth until more than about five seconds passed between each drip. The soaked cloth was then weighed on the scale 102.

With respect to some assumptions taken in Experiment 1, it may be possible that the soaking pan 100 material of fabrication, i.e., a plastic, and the dyed water enhanced partial fabric wicking due to a static charge or proximity. However, due to the similar testing environment for all cloth materials tested, it should be assumed that the soaking pan 100 material and the dyed water generally did not affect the results presented herein. It should be noted that the visible moisture was generally represented by the actual height reached. In addition, washed and unwashed fabric behaved substantially similarly in Experiment 1. It was anticipated that temperature would generally not affect absorption results.

Observations taken during Experiment 1 involve the red dye mixture 106, which generally requires stirring such that the dye does not settle to the bottom of the soaking pan 100. In some instances, the solution moved faster due to wicking, reaching the top of the cloth strip in approximately 10 seconds. Significant napping of a cloth was observed to disguise the full height. A spline roller 108 was therefore implemented to compress the cloth for viewing and/or measurement. In particular, the spline roller 108 was utilized from the top down, as it influenced (i.e., increased) the wicking height when rolling from a wet portion to a dry portion. For example, the visible height could be approximately 7.4 cm, while the actual height could be approximately 9.5 cm. The solution may also dry during experimentation, thereby lowering the level of the solution in the soaking pan 100 over time. The first nine samples generally removed solution from the soaking pan 100, so the baseline height of the solution was changed from about 5.5 cm to about 5.4 cm. Time was also a factor, as cloth left overnight generally made it to the top of the cloth strip. Further, the wicking height measured at approximately 3 minutes and approximately 6 minutes were generally substantially similar Thus, the wicking height measurements taken at 3 minutes were utilized. In addition, some fabric held air when submerged in the solution.

Experiment 1 Results

With reference to the above-described experimental study, experimentation results with respect to Experiment 1 were obtained and are set forth in Tables 1 and 2 below. In particular, Table 1 sorts the experimentation results by wicking height and Table 2 sorts the experimentation results by absorbance.

TABLE 1
Experimental Results Sorted By Wicking Height of Liquid

| Cloth | | Wicking Height |
|---|---|---|
| Label | Cloth Type | (cm) |
| N | pop bottle^{a} | 0.6 |
| P₁ | shade cloth | 0.6 |
| S₁ | cotton 1 | 0.6 |
| R | polyester voile (prototype) thin^{a} | 1.1 |
| Q | polyester voile (prototype) | 1.4 |
| P₂ | shade cloth sheer | 2 |
| L₂ | PE from NCSU 1/150 HE L₂ | 2.1 |
| D | polar fleece tan (100) | 2.5 |
| O | polar fleece 300^{a} | 2.6 |
| I | PE from NCSU 190 1/1^{a} | 2.8 |
| K₁ | PE from NCSU 2/150 HE K₁ | 3.4 |
| C | polar fleece (200) new^{b} | 3.5 |
| E | polar fleece (200) black^{a} | 3.5 |
| L₁ | PE from NCSU 1/150 HE L₁ | 3.6 |
| J | PE from NCSU 280 1/1 | 3.8 |
| K₂ | PE from NCSU 2/150 HE K₂^{a} | 4.2 |
| B | polar fleece (200) used short time^{a,b} | 4.5 |
| A | polar fleece (200) used long time^{b} | 5.5 |
| S₂ | cotton 2 | 6.4 |
| S₃ | cotton 3 | 6.4 |
| F | PE from NCSU 5.6A 2/2 | 7.5 |
| M | PE from NCSU 2/150 non-napped | 8.1 |
| V | PE from NCSU 4/1 | 8.1 |
| T | white spandex^{a} | 8.1 |

^{a}Cloth sample was to be utilized in Experiment 2 if sufficient cloth was available.
^{b}Cloth was utilized in previous experimental aeroponic systems.

TABLE 2
Experimental Results Sorted By Weight
of Cloth With Absorbed Liquid

| Cloth | | Weight | Absorbance |
|---|---|---|---|
| Label | Cloth Type | (g) | (g/cm²) |
| P₁ | shade cloth | 0.0 | 0.00 |
| P₂ | shade cloth sheer | 0.0 | 0.00 |
| T | white spandex^{a} | 1.21 | 0.04 |
| S₁ | cotton 1 | 2.0 | 0.09 |
| S₂ | cotton 2 | 2.0 | 0.09 |
| R | polyester voile (prototype) thin^{a} | 2.38 | 0.10 |
| J | PE from NCSU 280 1/1 | 3.0 | 0.13 |
| K₁ | PE from NCSU 2/150 HE K₁ | 3.0 | 0.13 |
| L₂ | PE from NCSU 1/150 HE L₂ | 4.0 | 0.18 |
| Q | polyester voile (prototype) | 4.0 | 0.18 |
| S₃ | cotton 3 | 4.0 | 0.18 |
| D | polar fleece tan (100) | 5.0 | 0.22 |
| L₁ | PE from NCSU 1/150 HE L₁ | 5.0 | 0.22 |
| K₂ | PE from NCSU 2/150 HE K₂^{a} | 5.54 | 0.22 |
| N | pop bottle^{a} | 5.94 | 0.26 |
| E | polar fleece (200) black^{a} | 6.20 | 0.26 |
| A | polar fleece (200) used long time^{b} | 6.1 | 0.27 |
| F | PE from NCSU 5.6A 2/2 | 6.1 | 0.27 |
| B | polar fleece (200) used short time^{a,b} | 6.40 | 0.27 |
| C | polar fleece (200) new^{b} | 7.0 | 0.31 |
| I | PE from NCSU 190 1/1^{a} | 7.38 | 0.29 |
| O | polar fleece 300^{a} | 7.68 | 0.32 |
| V | PE from NCSU 4/1 | 8.0 | 0.35 |
| M | PE from NCSU 2/150 non-napped | 9.0 | 0.40 |

^{a}Cloth sample was to be utilized in Experiment 2 if sufficient cloth was available.
^{b}Cloth was utilized in previous experiments.

Experimental Protocols for Experiments 2, 3 and 4

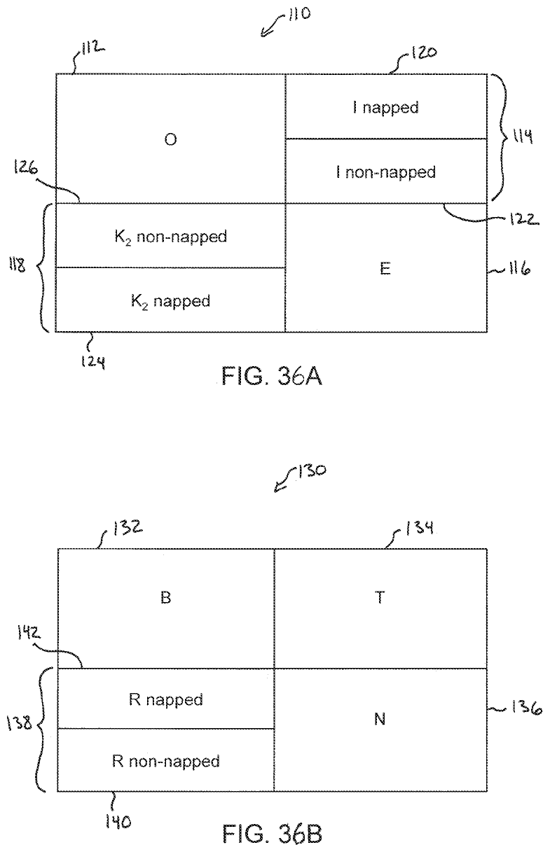

Cloth samples for Experiments 2, 3 and 4 were sewn into two flats as shown in FIGS. 36A and 36B. The exemplary flats were sewn together from different cloth samples, as described below, and measured approximately 150 cm by approximately 75 cm. In particular, one quarter of each flat was used to hold a sample. In instances where the cloth was different on both sides, e.g., napped on one side and non-napped on the other side, the quarter section of the flat was divided further into two parts with a sample of napped and non-napped cloth being sewn adjacent to each other. FIG. 36A shows an exemplary diagram for a first flat 110 for samples O, I, K₂ and E and FIG. 36B shows an exemplary diagram for a second flat 130 for samples B, T, R and N. In particular, the first flat 110 of FIG. 36A includes a first quarter 112 for sample O, a second quarter 114 for sample I, a third quarter 116 for sample E, and a fourth quarter 118 for sample K₂. As described above, due to the napped and non-napped sides of sample I and sample K₂, the second quarter 114 and the fourth quarter 118 were further divided into first, second, third and fourth eighths 120, 122, 124 and 126, respectively. Thus, the first eighth 120 was designated for the napped side of sample I, the second eighth 122 was designated for the non-napped side of sample I, the third eighth 124 was designated for the napped side of sample K₂, and the fourth eighth 124 was designated for the non-napped side of sample K₂.

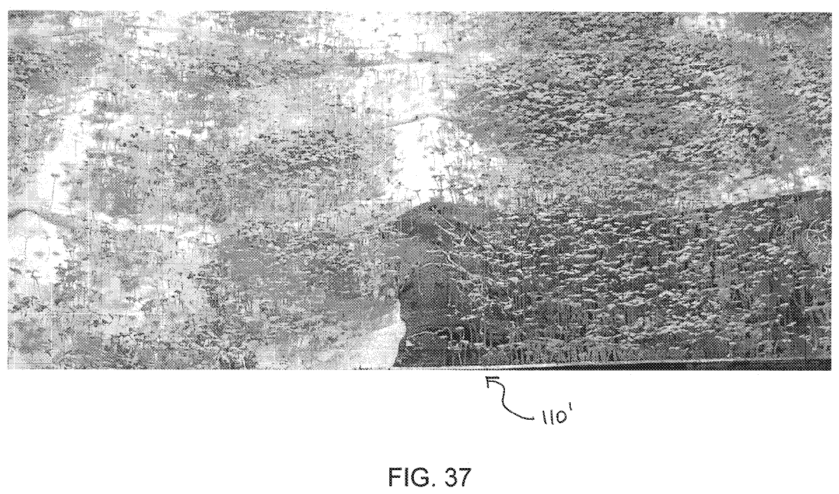

Similarly, the second flat 130 of FIG. 36B includes a first quarter 132 for sample B, a second quarter 134 for sample T, a third quarter 136 for sample N, and a fourth quarter 138 for sample R. Due to the napped and non-napped sides of sample R, the fourth quarter 138 was further divided into first and second eighths 140 and 142, respectively. Thus, the first eighth 140 was designated for the non-napped side of sample R and the second eighth 142 was designated for the napped side of sample R. FIG. 37 shows a photograph of an exemplary first flat 110′ as implemented in Experiments 2, 3 and 4.

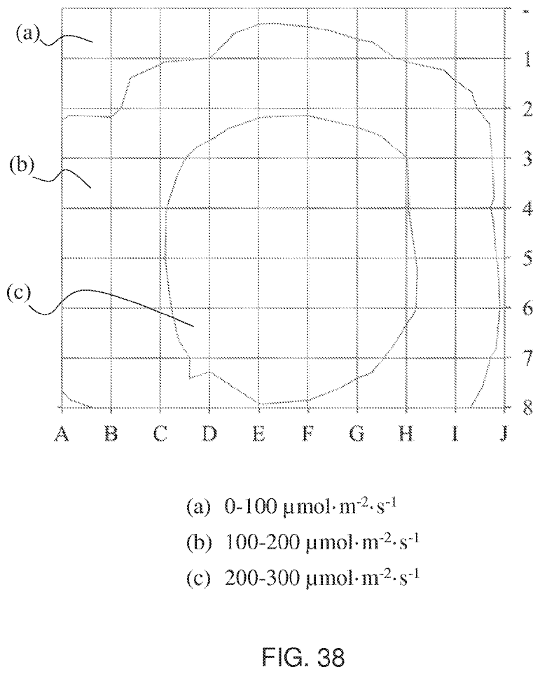

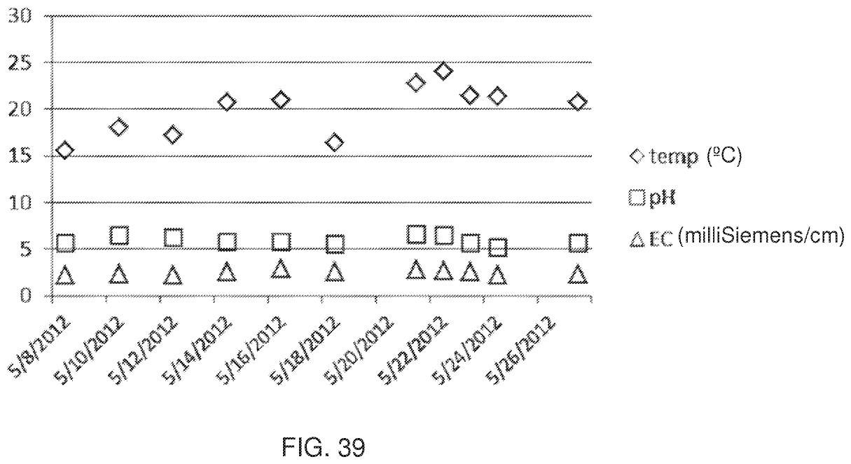

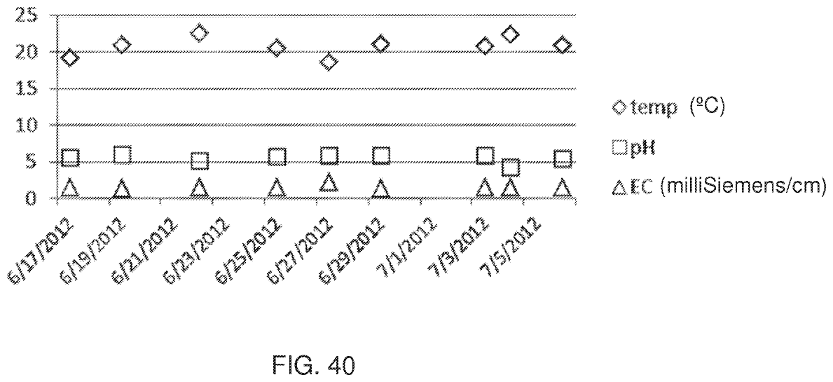

Growing of plants on the sample cloth materials was generally performed in a single growth chamber using approximately 400 Watt High Pressure Sodium (HPS) continuous lighting, providing the same nutrient solution, and having substantially similar temperature, air movement, and humidity. FIG. 38 illustrates a graph of the light intensity conditions in the growth chamber. Lighting intensity generally varied over the flats and may have influenced yields. In particular, as shown in FIG. 38, light intensity levels varied between approximately 0 μmol·m⁻²·s⁻¹ to 100 μmol·m⁻²·s⁻¹ in circle area “a”, approximately 100 μmol·m⁻²·s⁻¹ to approximately 200 μmol·m⁻²·s⁻¹ in circle area “b”, and approximately 200 μmol·m⁻²·s⁻¹ to approximately 300 μmol·m⁻²·s⁻¹ in circle area “c”. The impact caused by the variation of light intensity was substantially avoided by taking yields from the innermost circle area “c” in Experiment 4 (over about 200 μmol·m⁻²·s⁻¹) under the bulb. FIGS. 39 and 40 show additional climate conditions in the growth chamber, including the temperature measured in degrees Celsius, the pH level, and the electrical conductivity measured in dS/m. In particular, FIG. 39 shows climate conditions for Experiment 3, including a nutrient temperature range of approximately 15.6° C. to approximately 24.1° C., a pH level range of approximately 5.2 to approximately 6.6, and an electrical conductivity range of approximately 2.23 dS/m to approximately 2.86 dS/m. FIG. 40 shows climate conditions for Experiment 4, including a nutrient temperature range of approximately 18.6° C. to approximately 22.5° C., a pH level range of approximately 4.3 to approximately 6.0, and an electrical conductivity range of approximately 1.35 dS/m to approximately 2.15 dS/m.

Experiment 2

Experiment 2 focused on determining a germination percentage accounting for light variation. This involved determining the preferred covering for germination and the impact of cloth type on germination. In addition, Experiment 2 determined the relationship between wicking, absorbance, and seed germination. It should be noted that further testing protocol can be implemented to measure the speed of germination. The germination optimization protocol included utilization of (a) a translucent white cover, (b) a black opaque cover, and (c) no cover, to determine the desired light intensity and if the seeds required covering at all. Three different 1 inch squares on the cloth surface were used to count seeds germinated per cloth sample. Approximately twenty grams of “Astro” arugula (Eruca sativa) seed was used per flat.

Table 3 below shows the data for Experiment 2 with a ranking beginning with best germination (1) to the worst germination (11). It should be noted that use of the black opaque cover (b) generally provided the best germination overall. Thus, the results shown below in Table 3 are sorted by the germination and yield resulting from implementation of the black opaque cover (b). It should be understood that the designation of “napped” discussed in the Tables of the present disclosure refers to a cloth sample oriented with a napped surface facing the top side on which seeds are deposited and a non-napped surface facing the bottom side. Similarly, the designation of “non-napped” discussed in the Tables of the present disclosure refers to a cloth sample oriented with the non-napped surface facing the top side on which seeds are deposited and the napped surface facing the bottom side. Cotton (samples S₁, S₂ and S₃) and sheer samples (samples P₁ and P₂) were not utilized in Experiment 2 due to rapid deterioration and allowing nutrients to pass through the cloth too easily, respectively.

TABLE 3
Experimental Results For Germination and Yield Sorted By Cover B

| | | | | | | | Rank |
|---|---|---|---|---|---|---|---|
| Fabric | | | | | | | By |
| | Cov- | Percentage Germination | | | | | Cover |
| Cloth | er | 1 | 2 | 3 | Subtotal | Total | B |
| T | a | 100%^{a} | 100%^{a} | 100%^{a} | 100%^{a} | 100% | 1 |
| | b | 100%^{a} | 100%^{a} | 100%^{a} | 100%^{a} | | |
| | c | 100%^{a} | 100%^{a} | 100%^{a} | 100%^{a} | | |
| B | a | 100% | 100% | 100% | 100% | 72% | 2 |
| | b | 100% | 100% | 90% | 98% | | |
| | c | 25% | 7% | 0% | 12% | | |
| E | a | 33% | 62% | 45% | 44% | 56% | 3 |
| | b | 100% | 89% | 91% | 95% | | |
| | c | 0% | 11% | 22% | 15% | | |
| I | a | 33% | 50% | 91% | 64% | 92% | 4 |
| (napped) | b | 100%^{a} | 100% | 73% | 92% | | |
| | c | 93%^{a} | 88% | 100% | 92% | | |
| R | a | 100% | 85% | 100% | 95% | 50% | 5 |
| (non- | b | 76% | 100% | 100% | 86% | | |
| napped) | c | 0% | 11% | 0% | 3% | | |
| O | a | 50% | 87% | 69% | 68%^{a} | 85% | 6 |
| | b | 91% | 90% | 75% | 85% | | |
| | c | 90% | 81% | 58% | 75% | | |
| R | a | 44% | 88% | 0% | 48% | 44% | 7 |
| (napped) | b | 89% | 23% | 100% | 68% | | |
| | c | 0% | 93% | 25% | 27% | | |
| K₂ | a | 100% | 100% | 54% | 83% | 79% | 8 |
| (non- | b | 100% | 100% | 10% | 61% | | |
| napped) | c | 100% | 100% | 100% | 100% | | |
| I | a | 67% | 94% | 65% | 75% | 61% | 9 |
| (non- | b | 13% | 93% | 0% | 44% | | |
| napped) | c | 0% | 100%^{a} | 33% | 52% | | |
| K₂ | a | 0% | 0% | 33% | 15% | 17% | 10 |
| (napped) | b | 0% | 17% | 34% | 18% | | |
| | c | 71% | 0% | 0% | 20% | | |
| N | a | 0% | 0% | 0% | 0% | 33% | 11 |
| | b | 18% | 0% | 0% | 10% | | |
| | c | 0% | 96%^{a} | 0% | 65% | | |
| Overall | a | 48% | 63% | 49% | 53% | 53% | |
| | b | 67% | 71% | 51% | 63% | | |
| | c | 34% | 62% | 30% | 43% | | |

^{a}Cloth sample was extremely wet.

It should be noted that moisture, e.g., water, nutrient solution, and the like, is generally the key ingredient in germination. For example, it was observed that very wet areas on a single cloth sample generally had better germination rates than other less wet areas on the same cloth sample. Cloth samples that had greater water overall generally germinated better. However, areas of cloth samples that were sloped generally did not germinate as well and were drier. In particular, extremely wet conditions were generally located at drooping areas of the cloth samples which caused the formation of puddles.

Experiment 3

Experiment 3 generally focused on determining plant yield as a function of cloth type. In particular, Experiment 3 was a continuation of Experiment 2 by allowing the plants to grow to approximately harvest size and weighing each treatment. The cloth samples were initially seeded and covered for germination with approximately twenty grams of “Astro” arugula (Eruca sativa) seed per flat. Approximately two days after seeding, the covers were removed from the growth chamber and approximately seventeen days later, the plants were harvested. Thus, the plants were grown for approximately nineteen days total.

Care was taken in cutting the harvested plants at substantially the same height for each section. Where the cloth sample was split into two equally-sized sections, e.g., samples K, I and R, the yield was doubled to determine a projected density of the plant. It was noted that the differences in plant height, varied light intensity, and/or nutrient spray may have impacted yields. For example, plants in regions receiving less than approximately 200 μmol·m⁻²·s⁻¹ of light were generally observed to reach smaller plant heights. The results for Experiment 3 are provided below in Table 4. In particular, the results shown in Table 4 are ranked by density of the harvested plant beginning with the lowest density (11) and ending with the highest density (1).

TABLE 4
Experimental Results For Yield Sorted By Density

| Cloth | Weight | | | Rank By |
|---|---|---|---|---|
| Sample | (lbs) | Density | Germination | Density |
| T | 0.095 | 0.095 | 100% | 11 |
| N | 0.105 | 0.105 | 33% | 10 |
| K₂ (napped) | 0.090 | 0.180 | 17% | 9 |
| B | 0.240 | 0.240 | 72% | 8 |
| K₂ (non-napped) | 0.130 | 0.260 | 79% | 7 |
| E | 0.290 | 0.290 | 56% | 6 |
| O | 0.305 | 0.305 | 85% | 5 |
| I (non-napped) | 0.155 | 0.310 | 61% | 4 |
| I (napped) | 0.205 | 0.410 | 92% | 3 |
| R (napped) | 0.215 | 0.430 | 44% | 2 |
| R (non-napped) | 0.320 | 0.640 | 50% | 1 |

Experiment 4

Similar to Experiment 3, Experiment 4 was generally focused on determining plant yield as a function of cloth type. In particular, Experiment 4 generally removed the variations involved in Experiment 3, e.g., the differences in nutrient spray patterns were removed, plants were picked from areas receiving sufficient light levels, and the like. Experiment 4 also utilized different seeds than Experiment 3, as described below.

The cloth flats were scraped to be substantially free of stems and/or roots and then washed in a washing machine with detergent. The cloth flats were then replanted with Asian greens, i.e., approximately 10 grams each of Fun Jen (Brassica rapa var. chinesis) and Komatsuna (Brassica rapa var. perviridis) seed per flat. At harvest size, about seventeen plants were pulled from the cloth with roots intact and weighed individually, thereby providing an average plant weight and a total for each cloth treatment. It was determined that the individual plant weight did not add essential information and, thus, the total weight of the seventeen harvested plants was used. The results for Experiment 4 are provided below in Table 5 and are sorted by total weight beginning with the highest weight, i.e., 13.44 grams from sample R (napped), and ending with the lowest weight, i.e., 4.60 grams from sample E.

TABLE 5
Experimental Results For Yield Sorted By Total Weight

| Cloth | Germination | Total Weight |
|---|---|---|
| Sample | (%) | (g) |
| R (napped) | 99% | 13.44 |
| N | 93% | 12.49 |
| R (non-napped) | 97% | 11.46 |
| B | 98% | 11.41 |
| I (non-napped) | 96% | 8.79 |
| I (napped) | 100% | 8.78 |
| K₂ (non-napped) | 98% | 7.96 |
| O | 93% | 7.57 |
| K₂ (napped) | 56% | 6.76 |
| T | 86% | 6.48 |
| E | 94% | 4.60 |

It should be noted that the higher level of germination in Experiment 4 versus the level of germination in Experiment 3 may be a result of the opaque cover and/or washing the flats. In particular, Experiment 4 utilized a single opaque cover for the entire flat as compared to Experiment 3, where the germination was performed with assorted covers. With respect to washing the flats as a cause for the higher level of germination, surface treatments may have been used on the cloth flats of yet unused fabric and removed during the washing cycle. As a further example, the washing cycle may have “softened” the fabric by creating yarn surface cracking.

Experimental Results

The desired result of performing the above-described experiments generally involved the determination of a range of absorbance parameters and/or wicking parameters that describe satisfactory performance for aeroponically germinating and/or growing plants. The cloth samples tested were ranked in order to determine these parameters. A summation of the ranking of cloth samples based on the above experiments is provided below in Tables 6 and 7. In particular, Table 6 provides a ranking of cloth samples based on a comparison of the yield and germination percentage data determined in Experiments 2, 3 and 4, while Table 7 provides a ranking of cloth samples based on a combined ranking score for yield and germination percentage determined in Experiments 2, 3 and 4. The rankings in Table 6 are shown from lowest yield or germination at the top (first) to highest yield or germination at the bottom (eleventh). The rankings in Table 7 were determined by summing the cloth performance ranking in each column, i.e., summing the rankings of Table 6 for yield performance in Experiments 3 and 4 and summing the germination performance rankings in Experiments 2 and 4. The rankings in Table 7 are listed from highest yield or germination (21) to lowest yield or germination (2). For example, cloth sample T in Table 6 is ranked number one (1) in Experiment 3 (i.e., lowest yield) and number two (2) in Experiment 4 (i.e., second lowest yield), thus providing a sum of three (3). Similarly, cloth sample E in Table 6 is ranked number six (6) in Experiment 3 (i.e., sixth lowest yield) and number one (1) in Experiment 4 (i.e., lowest yield), thus providing a sum of seven (7).

TABLE 6
Samples Ranked By Yield and Germination Percentage

| Yield Comparison | | Germination Comparison | |
|---|---|---|---|
| Experiment 3 | Experiment 4 | Experiment 2 | Experiment 4 |
| T | E | K₂ (napped) | K₂ (napped) |
| N | T | N | T |
| K₂ (napped) | K₂ (napped) | R (napped) | N^{b} |
| B | O | R (non-napped) | O |
| K₂ | K₂ | E | E |
| (non-napped) | (non-napped) | | |
| E | I (non-napped) | I (non-napped) | I (non-napped) |
| O^{c} | I (napped) | B | R (non-napped)^{c} |
| I (non-napped)^{b} | B | K₂ | K₂ |
| | | (non-napped) | (non-napped) |
| I (napped)^{b} | R (non-napped)^{c} | O | B |
| R (napped)^{a} | N^{b} | I (napped) | R (napped)^{a} |
| R (non-napped)^{a} | R (napped)^{a} | T | I (napped) |

^{a}Cloth sample resulted in best yield.
^{b}Cloth sample resulted in the second best yield.
^{c}Cloth sample resulted in the third best yield.

TABLE 7
Combined Ranking Score of Yield and Germination

| Yield Comparison | | Germination Comparison | |
|---|---|---|---|
| Sample | Rank Score | Sample | Rank Score |
| T | 3 | K₂ (napped) | 2 |
| K₂ (napped) | 6 | N | 5 |
| E | 7 | E | 10 |
| K₂ (non-napped) | 10 | T | 13 |
| O | 11 | O | 13 |
| B | 12 | R (non-napped) | 13 |
| N | 12 | R (napped) | 13 |
| I (non-napped) | 14 | I (non-napped) | 15 |
| I (napped) | 16 | K₂ (non-napped) | 16 |
| R (non-napped) | 20 | B | 16 |
| R (napped) | 21 | I (napped) | 21 |

The rankings provided in Tables 6 and 7 generally compare germination success with yield success. The anticipated strong relationship is present in sample R (napped). However, as can be seen from Tables 6 and 7, other cloth samples also performed well in both categories. Although sample T (white spandex) performed well in several cases, sample T also killed some plants before the plant reached full maturity due to its characteristic of permitting excessive water to move to and remain on the cloth surface. The excessive water remaining on sample T generally supported disease and/or drowned some of the smaller plants. Sample N (pop bottle fabric) generally drained so rapidly that the surface with seeds did not feel moist after the cover was removed. In addition, sample N generally performed poorly during the washing cycle in the washing machine and would therefore not be expected to last long during repeated cycles of germination, harvesting, and washing. Sample K₂ (napped) (PE from NCSU 2/150 HE) defined a napped surface which generally held seeds away from the moisture of the underlying fabric by preventing moisture from wicking high enough.

The rankings shown in Tables 6 and 7 for yield and germination data were implemented to compare the related absorbance data and wicking data of the cloth samples as shown in Table 8 below.

TABLE 8
Absorbance and Wicking Data Comparison

| Compare Yields | | | | Compare Germination % | | | |
|---|---|---|---|---|---|---|---|
| | Rank | Absorbance | Wicking | | Rank | Absorbance | Wicking |
| Sample | Score | (g/cm²) | (cm) | Sample | Score | (g/cm²) | (cm) |
| T | 3 | 0.04 | 8.1 | K₂ | 2 | 0.22 | 4.2 |
| | | | | (napped) | | | |
| K₂ | 6 | 0.22 | 4.2 | N | 5 | 0.26 | 0.6 |
| (napped) | | | | | | | |
| E | 7 | 0.26 | 3.5 | E | 10 | 0.26 | 3.5 |
| K₂ | 10 | 0.22 | 4.2 | T | 13 | 0.04 | 8.1 |
| (non-napped) | | | | | | | |
| O | 11 | 0.32 | 2.6 | O | 13 | 0.32 | 2.6 |
| B | 12 | 0.27 | 4.5 | R | 13 | 0.10 | 1.1 |
| | | | | (non-napped) | | | |
| N | 12 | 0.26 | 0.6 | R | 13 | 0.10 | 1.1 |
| | | | | (napped) | | | |
| I | 14 | 0.29 | 2.8 | I | 15 | 0.29 | 2.8 |
| (non-napped) | | | | (non-napped) | | | |
| I | 16 | 0.29 | 2.8 | K₂ | 16 | 0.22 | 4.2 |
| (napped) | | | | (non-napped) | | | |
| R | 20 | 0.10 | 1.1 | B | 16 | 0.27 | 4.5 |
| (non-napped) | | | | | | | |
| R | 21 | 0.10 | 1.1 | I | 21 | 0.29 | 2.8 |
| (napped) | | | | (napped) | | | |

In particular, based on the experimental data and rankings discussed above, ranges of absorbance parameters and wicking parameters were determined as descriptive of the maximum range for a preferred cloth to be implemented in an aeroponic system. For an optimal yield, a preferred range of the wicking parameter, i.e., the wicking height, was determined to be between approximately 0.6 cm and approximately 8.1 cm, specifically between approximately 0.6 cm and approximately 4.5 cm, and more specifically between approximately 1.1 cm and approximately 2.8 cm. A preferred range of the absorbance parameter for an optimal yield was determined to be between approximately 0.04 g/cm² and approximately 0.32 g/cm², specifically between approximately 0.10 g/cm² and approximately 0.32 g/cm², and more specifically between approximately 0.10 g/cm² and approximately 0.29 g/cm². For an optimal germination, a preferred range of the wicking parameter was determined to be between approximately 0.6 cm and approximately 8.1 cm, specifically between approximately 1.1 cm and approximately 8.1 cm, and more specifically between approximately 2.8 cm and approximately 4.5 cm. A preferred range of the absorbance parameter for an optimal germination was determined to be between approximately 0.04 g/cm² and approximately 0.32 g/cm², specifically between approximately 0.22 g/cm² and approximately 0.29 g/cm².

Thus, for a cloth material exhibiting optimal yield and germination, the preferred range of the wicking parameter was determined to be between approximately 0.6 cm and approximately 8.1 cm, specifically between approximately 1.1 cm and approximately 4.5 cm. The preferred range of the absorbance parameter for a cloth material exhibiting optimal yield and germination was determined to be between approximately 0.10 g/cm² and approximately 0.29 g/cm², specifically between approximately 0.22 g/cm² and approximately 0.29 g/cm². It should be noted that the preferred ranges of the wicking parameter and the absorbance parameter can vary depending on, e.g., the methods implemented for supplying nutrient solution to the cloth/fabric such that the proper level of nutrient solution is maintained during the germination and/or growing periods. The experimental results provide preferred wicking parameter and absorbance parameter ranges and shows that wicking and absorbance characteristics of cloth/fabric may be used to select optimal cloth/fabric materials for use in aeroponic systems. Cloth materials having a wicking parameter and/or an absorbance parameter greater than those listed above may be too damp and can drown seedlings and/or create conditions which enhance fungal growth. Cloth materials having a wicking parameter and/or an absorbance parameter less than those listed above may create poor germination conditions. Although the results discussed herein were determined from experimentation with a water-based solution, it is believed that the results and preferred ranges for the wicking parameter and the absorbance parameter are predictive for aeroponic systems implementing a nutrient solution.

Alternative farming systems may benefit from cloth materials with the properties disclosed herein. For example, in some embodiments, the cloth or fabric materials discussed herein may be implemented in a hydroponic system. Seeds can be deposited on the cloth or fabric and the cloth or fabric can be immersed in a nutrient solution and/or constantly sprayed with a nutrient solution on at least one surface during a germination period. The cloth or fabric thereby provides the seeds with controlled access and/or constant replenishing of the nutrient solution for germination and further provides support for the seeds and for root penetration. Once the germination period has passed, the cloth or fabric can be removed from the nutrient solution and/or the spraying of the nutrient solution can be provided in reduced intervals during a period of plant growth.

As would be understood by those of ordinary skill in the art, a cloth material having a wicking parameter and/or an absorbance parameter greater or less than the ranges provided above may still be implemented as a growing medium for systems which supply the moisture needed to germinate seeds. For example, although sample N (pop bottle fabric) generally fails to meet the wicking and absorbance parameters listed above, placing a seeded sample N directly into a tray of nutrient solution and/or water may permit germination of seeds and growth of the plant. The germination and/or growth of the plant may result due to the constant supply of nutrient solution and/or water to the seeds. However, cloth materials which fail to meet the wicking and/or absorbance parameters listed above generally would not promote the maximum yield and/or germination in aeroponic systems.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An aeroponic system, comprising:
an aeroponic growth chamber,
a cloth or fabric positioned within the aeroponic growth chamber, the cloth or fabric defining an upper surface and a lower surface, and exhibiting (i) a wicking height parameter characterized by a wicking height range from 1.1 cm to 4.5 cm, and (ii) an absorbance parameter characterized by an absorbance range from 0.10 g/cm² to 0.29 g/cm²,
wherein the upper surface is napped and the lower surface is non-napped.

2. The aeroponic system of claim 1, wherein a weave and yarn of the cloth or fabric facilitates root penetration.

3. The aeroponic system of claim 1, wherein the cloth or fabric provides a substantial barrier to nutrient solution spray.

4. The aeroponic system of claim 1, further comprising at least one of cloth or fabric support elements, a light source and a nutrient solution source.

5. The aeroponic system of claim 1, wherein the cloth or fabric is selected from a group consisting of a polyester material, an acrylic material, and a non-biodegradable synthetic material.

6. The aeroponic system of claim 1, wherein the aeroponic system satisfies a plurality of germination parameters that include at least one of a temperature range, a pH level range, a relative humidity range, a light intensity range, a light spectrum, an electrical conductivity range, and a carbon dioxide level range.

7. The aeroponic system of claim 6, wherein the temperature range is from 5° C. to 35° C.

8. The aeroponic system of claim 6, wherein the pH level range is from 4 to 8.

9. The aeroponic system of claim 6, wherein the relative humidity range is from 20% to 100%.

10. The aeroponic system of claim 6, wherein the light intensity range is from 0 μmol·m⁻²·s⁻¹ to 250 μmol·m⁻²·s⁻¹.

11. The aeroponic system of claim 6, wherein the light spectrum is from 400 nm to 700 nm.

12. The aeroponic system of claim 6, wherein the electrical conductivity range is from 1.5 dS·m⁻¹ to 3.0 dS·m⁻¹.

13. The aeroponic system of claim 1, wherein the wicking height parameter is characterized by a wicking height range from 2.8 cm to 4.5 cm, and (ii) the absorbance parameter is characterized by an absorbance range from 0.22 g/cm² to 0.29 g/cm².

14. The aeroponic system of claim 1, wherein the cloth or fabric is selected from a group consisting of a polyester material, an acrylic material, and a non-biodegradable synthetic material.

15. A method of aeroponic farming, comprising:
providing an aeroponic system that includes a growth chamber,
selecting a cloth or fabric for positioning within the growth chamber, the cloth or fabric defining an upper surface and a lower surface, and exhibiting (i) a wicking height parameter characterized by a wicking height range from 1.1 cm to 4.5 cm, and (ii) an absorbance parameter characterized by an absorbance range from 0.10 g/cm² to 0.29 g/cm², wherein the upper surface is napped and the lower surface is non-napped,
supporting the selected cloth or fabric within the growth chamber; and
depositing seeds on the napped upper surface of the selected cloth or fabric that is supported within the growth chamber.

16. The method of aeroponic farming of claim 15, further comprising spraying a nutrient solution on at least one surface of the cloth or fabric.

17. The method of aeroponic farming of claim 15, wherein the wicking height parameter is characterized by a wicking height range from 2.8 cm to 4.5 cm, and (ii) the absorbance parameter is characterized by an absorbance range from 0.22 g/cm² to 0.29 g/cm².

18. The method of aeroponic farming of claim 15, wherein the cloth or fabric is selected from a group consisting of a polyester material, an acrylic material, and a non-biodegradable synthetic material.

19. A system for farming, comprising:
a growth chamber,
a cloth or fabric positioned within the growth chamber, the cloth or fabric defining an upper surface and a lower surface, and exhibiting (i) a wicking height parameter characterized by a wicking height range from 1.1 cm to 4.5 cm, and (ii) an absorbance parameter characterized by an absorbance range from 0.10 g/cm² to 0.29 g/cm²,
wherein the upper surface of the cloth or fabric on which seeds are deposited is napped, and the lower surface is non-napped.

20. The system of claim 19, further comprising at least one of cloth or fabric support elements, a light source and a nutrient solution source.

21. The system of claim 19, wherein the cloth or fabric is selected from a group consisting of a polyester material, an acrylic material, and a non-biodegradable synthetic material.

22. The system of claim 19, wherein the wicking height parameter is characterized by a wicking height range from 2.8 cm to 4.5 cm, and (ii) the absorbance parameter is characterized by an absorbance range from 0.22 g/cm² to 0.29 g/cm².
